(19) United States
(12) Patent Application Publication
(10) Pub. No.: US 2025/0228403 A1
(43) Pub. Date: Jul. 17, 2025

(54) CUTTING TOOL DEVICE AND FOOD PROCESSOR THEREOF

(71) Applicant: Foshan Shunde Topway Technology Industrial CO., LTD, Foshan (CN)

(72) Inventor: JIANBO HE, Foshan (CN)

(21) Appl. No.: 18/909,254

(22) Filed: Oct. 8, 2024

(30) Foreign Application Priority Data
Jan. 11, 2024 (CN) 202410047787.0

(51) Int. Cl. A47J 43/07; B26D 3/22

(52) U.S. Cl. CPC A47J 43/0716; B26D 3/22; B26D 2210/02

(57) ABSTRACT

The present invention discloses a cutting tool device and a food processor thereof, the cutting tool device comprises a cutting tool holder and a first cutting tool thereon, and the cutting tool holder is provided with a first blocking portion on one side of the connection between the cutting tool holder and the first cutting tool, and an avoidance space is provided on the first cutting tool corresponding to the position of the first blocking portion; when the avoidance space of the first cutting tool moves close to the first blocking portion on the cutting tool holder, the first blocking portion fits the avoidance space of the first cutting tool to cut off large pieces of food stuck on the first cutting tool, so that the food doesn't get stuck on the first cutting tool and the cutting performance of the first cutting tool is significantly improved.

### CROSS-REFERENCE TO RELATED APPLICATIONS

This application claims priority to Chinese Patent Application No. 202410047787.0, filed on Jan. 11, 2024, which is hereby incorporated by reference in its entirety.

### TECHNICAL FIELD

The present invention relates to a cutting tool device and a food processor thereof.

### BACKGROUND

The existing food processors, such as juicers, as detailed in Chinese invention patent application CN 201980029237.3, titled “A Juicer”, published on Jun. 22, 2021, comprises a juicer cylinder that accommodates a screw for squeezing juicing materials inside, and a hopper, combined with the upper part of the juicer to form a space for accommodating the juicing material, the hopper comprises a cutting portion that is rotatably coupled to the lower end surface of the hopper and used for cutting juicing material, and an open space for feeding the juicing material is provided on the upper side of the cutting portion in the hopper.

The juicer with the above structure, however, still has the following shortcomings: (1) During the use of the juicer, the larger juicing material that is prone to get stuck on the cutting portion will rotate together with the cutting portion, resulting in the cutting failure and affecting the normal operation, cutting effect and efficiency of the cutting portion.

### SUMMARY

The purpose of the present invention is to address the shortcomings of the above-mentioned prior art by providing a cutting tool device that prevents food from easily getting stuck on the cutting tool and improves the cutting effect of the device.

The second purpose of the present invention is to provide a food processor with ideal cutting effect and improved food processing efficiency.

The third purpose of the present invention is to provide a food processor with ideal cutting effect and improved food processing efficiency.

The first purpose of the present invention is achieved as follows:

A cutting tool device comprises a cutting tool holder and a first cutting tool thereon, and the cutting tool holder is provided with a first blocking portion on one side of the connection between the cutting tool holder and the first cutting tool, and an avoidance space is provided on the first cutting tool corresponding to the position of the first blocking portion; when the avoidance space of the first cutting tool moves close to the first blocking portion on the cutting tool holder, the first blocking portion fits the avoidance space of the first cutting tool to cut off large pieces of food stuck on the first cutting tool, so that the food doesn't get stuck on the first cutting tool and the cutting performance of the first cutting tool is significantly improved.

The purpose of the present invention can also be solved by the following technical measures:

Specifically, in further, a second blocking portion is further provided on the cutting tool holder, and the first cutting tool comprises a first cutting section on which an avoidance space is provided, and a second cutting section which inner surface is close to the outer surface of the second blocking portion; the integral fit among the first blocking portion, the second blocking portion, and the first cutting tool improves the cutting efficiency of the first cutting tool as a whole by preventing foot from getting stuck on the first cutting tool; additionally, the outer surface of the second blocking portion can effectively scrape the inner surface of the second cutting section to reduce the adhesion of food thereon.

Specifically, in further, the second blocking portion is located on the other side of the connection between the cutting tool holder and the first cutting tool, and the highest point of the second blocking portion is lower than the highest point of the first blocking portion, in order to enable the first blocking portion and the second blocking portion to function independently, that is, the first blocking portion and first cutting section cooperate to cut off large pieces of food stuck on the first cutting section, and the second blocking portion and second cutting section cooperate to cut off small pieces of food stuck on the second cutting section, providing a better effect.

Specifically, in further, the first cutting section is in an inverted “U” shape, the second cutting section is in a “U” shape, and the first cutting section and the second cutting section are integrally formed, in order to enable the first cutting tool to be manufactured as a whole in one go and conveniently and, additionally, the inverted “U” shaped first cutting section and “U” shaped second cutting section provide the first cutting tool with a longer cutting surface, significantly improving the overall cutting efficiency of the first cutting tool.

Specifically, in further, the first blocking portion and the second blocking portion are both provided with material guide slopes, so that the cut food can flow out of the cutting tool holder through the inclined guide surface.

Specifically, in further, the cutting tool holder comprises a left support section, a central connection portion, and a right support section connected in sequence, one end of the first cutting tool is rotatably connected to the central connection portion, the left support section extends upward and is provided with the first blocking portion, and the right support section extends upward and is provided with the second blocking portion; the left support section, central connection section, and right support section, which are reasonably set up, function independently and have good implementation effects.

Specifically, in further, the cutting tool device further comprises a tool connection assembly that is rotatably connected to the central connection portion, and the upper portion of the cutting tool connection assembly is fixedly connected to the first cutting tool, and the lower portion of the cutting tool connection assembly is provided with a driving hole.

Specifically, in further, the inner surface of the avoidance space is close to the outer surface of the first blocking portion; the outer surface of the second blocking portion can effectively scrape the inner surface of the second cutting section to reduce the adhesion of food thereon, improving the cutting effect of the first cutting tool.

Specifically, in further, a second cutting tool is further provided on the first cutting tool located on one side of the connection between the first cutting tool and the cutting tool holder, and the first blocking portion comprises a vertical section and a horizontal section, the horizontal section is connected to the upper portion of the vertical section, and when the second cutting tool rotates through the first blocking portion the second cutting tool is close to the corresponding inner surfaces of the vertical section and horizontal section; on one hand, adding a second cutting tool can increase the cutting efficiency of the cutting tool device and, on the other hand, the fit between the inner surface of the vertical section and horizontal section and the second cutting tool can cut off large pieces of food stuck on the second cutting tool, so that the food will not get stuck on the second cutting tool, that is, the first blocking portion fits well with the first cutting tool and second cutting tool, providing ideal implementation effect.

Specifically, in further, cutting edges are provided on both sides of the vertical section and horizontal section, so that the vertical section and horizontal section can easily cut the food stuck on the first or second cutting tool.

Specifically, in further, the first blocking portion is detachably connected to the cutting tool holder, so that the first blocking portion can be conveniently disassembled for cleaning or replacement.

Specifically, in further, the outer side of the first cutting tool further extends downward and is provided with a scraping portion, in order to facilitate the scraping operation of the scraping portion on the corresponding part (such as the inner wall of the feeding cylinder), providing better scraping effect.

Specifically, in further, a second cutting tool is further provided on the first cutting tool located on one side of the connection between the first cutting tool and the cutting tool holder, the first blocking portion is in a vertical hook shape, and when the second cutting tool rotates through the first blocking portion, the second cutting tool is close to the inner surface of the vertical hook shaped first blocking portion; on one hand, adding a second cutting tool can increase the cutting efficiency of the cutting tool device and, on the other hand, the fit between the inner surface of the vertical hook shaped first blocking portion and the second cutting tool can cut off large pieces of food stuck on the second cutting tool, so that the food will not get stuck on the second cutting tool, that is, the first blocking portion of the vertical hook shaped first blocking portion fits well with the first cutting tool and second cutting tool, providing ideal implementation effect.

The second purpose of the present invention is achieved as follows:

A food processor comprising the above-mentioned cutting tool device, comprises a main body, a pressing assembly, and a feeding cylinder, the main body is provided with an output shaft, the feeding cylinder is provided with a feeding port and a discharging port, the feeding cylinder is internally provided with a cutting tool holder and the first cutting tool, and the main body, through the output shaft, drives the pressing assembly and first cutting tool to rotate; for this food processor, a cutting tool holder and a first cutting tool are installed in the feeding cylinder, and the food entering the feeding cylinder is initially cut by the first cutting tool and then pressed and ground by the pressing assembly, so that the first cutting tool has better cutting effect, and improves the processing efficiency of food.

Specifically, in further, the inner wall of the feeding cylinder is provided with a pre-cutting protrusion that is located above the first cutting tool, the pre-cutting protrusion is provided with a pre-cutting tip, and the bottom surface of the pre-cutting protrusion is close to the outer surface of the first cutting tool; the pre-cutting protrusion with a pre-cutting tip inside the feeding cylinder can vertically pre-cut the food placed in the feeding cylinder, and then cooperate with the first cutting tool (to rotate) for circumferential (transverse) cutting to fully cut the food, further improving the cutting effect and efficiency; additionally, the bottom surface of pre-cut protrusion can ensure the sharpness of outer surface of the first cutting tool by scraping the materials thereon.

Specifically, in further, the feeding cylinder comprises an upper cylinder and a lower cylinder, the upper cylinder is detachably fixed on the lower cylinder, the upper portion of upper cylinder is provided with a feeding port, the bottom of lower cylinder is provided with a discharging port, and the lower cylinder is integrally provided with a cutting tool holder that is located near the discharging port, so that the upper and lower cylinders can be separately manufactured and formed to reduce the manufacturing difficulty of feeding cylinder and, additionally, the cutting tool holder and lower cylinder are integrally formed to facilitate their manufacturing.

The third purpose of the present invention is achieved as follows:

A food processor comprising the above-mentioned cutting tool device comprises a main body, a pressing assembly, and a feeding cylinder, the main body is provided with an output shaft, the feeding cylinder is provided with a feeding port and a discharging port, the pressing assembly is internally provided with the cutting tool holder and the first cutting tool, and the main body, through the output shaft, drives the pressing assembly and first cutting tool to rotate; for this food processor, a cutting tool holder and a first cutting tool are installed in the pressing assembly, and the food entering the pressing assembly is initially cut by the first cutting tool and then pressed and ground by the pressing assembly, so that the first cutting tool has better cutting effect, and improves the processing efficiency of food.

Specifically, in further, the pressing assembly comprises a filter screen, and a transmission screw that is placed inside the filter screen, the lower portion of the transmission screw is connected to the output shaft of the main body, and the upper portion of the transmission screw is provided with a screw shaft that is connected to the first cutting tool; on the one hand, the output shaft of the main body enables the transmission screw rotation inside the filter screen, ensuring the grinding assembly to press and grind and on the other hand, the output shaft of the main body, through the transmission screw, drives the first cutting tool to rotate, enabling the first cutting tool to cut with ideal effect.

Specifically, in further, the upper portion of the filter screen is provided with two opposite placement grooves, and the two ends of the cutting tool holder are respectively placed onto the two placement grooves on the upper portion of the filter screen, and the cutting tool holder is located above the transmission screw; the placement groove enables the detachable installation of the cutting tool holder on the filter screen, ensuring stable installation of the cutting tool holder on the filter screen and facilitating cleaning after disassembly of the cutting tool holder and filter screen.

Specifically, in further, the two ends of the cutting tool holder are integrally formed with the upper portion of the filter screen, and the cutting tool holder is located above the transmission screw, so that the cutting tool holder and filter screen can be conveniently manufactured at once.

The present invention has the following beneficial effects:

For the cutting tool device, when the avoidance space of the first cutting tool moves close to the first blocking portion on the cutting tool holder, the first blocking portion fits the avoidance space of the first cutting tool to cut off large pieces of food stuck on the first cutting tool, so that the food doesn't get stuck on the first cutting tool and the cutting performance of the first cutting tool is significantly improved.

(1) The integral fit among the first blocking portion, the second blocking portion, and the first cutting tool improves the cutting efficiency of the first cutting tool as a whole by preventing foot from getting stuck on the first cutting tool; additionally, the outer surface of the second blocking portion can effectively scrape the inner surface of the second cutting section to reduce the adhesion of food thereon.

(2) On one hand, adding a second cutting tool can increase the cutting efficiency of the cutting tool device and, on the other hand, the fit between the inner surface of the vertical section and horizontal section and the second cutting tool can cut off large pieces of food stuck on the second cutting tool, so that the food will not get stuck on the second cutting tool, that is, the first blocking portion fits well with the first cutting tool and second cutting tool, providing ideal implementation effect.

(3) For this food processor, a cutting tool holder and a first cutting tool are installed in the feeding cylinder, and the food entering the feeding cylinder is initially cut by the first cutting tool and then pressed and ground by the pressing assembly, so that the first cutting tool has better cutting effect, and improves the processing efficiency of food.

(4) The placement groove enables the detachable installation of the cutting tool holder on the filter screen, ensuring stable installation of the cutting tool holder on the filter screen and facilitating cleaning after disassembly of the cutting tool holder and filter screen.

### BRIEF DESCRIPTION OF DRAWINGS

FIG. 1 is a schematic diagram of the first embodiment of the food processor according to the present invention.

FIG. 2 is a sectional view of the feeding cylinder in to the first embodiment of the present invention.

FIG. 3 is an enlarged 3D view of the lower cylinder in the first embodiment of the present invention.

FIG. 4 is a schematic diagram from another angle of FIG. 3.

FIG. 5 is an enlarged 3D view of the first cutting tool in the first embodiment of the present invention.

FIG. 6 is a schematic diagram of the second embodiment of the cutting tool device of the present invention.

FIG. 7 is a disassembly diagram of the second embodiment of the cutting tool device of the present invention.

FIG. 8 is a schematic diagram of the third embodiment of the cutting tool device of the present invention.

FIG. 9 is a schematic diagram of the second embodiment of the food processor of the present invention.

FIG. 10 is a schematic diagram of the third embodiment of the food processor of the present invention.

### DESCRIPTION OF EMBODIMENTS

The present invention is further described in conjunction with the accompanying drawings and embodiments:

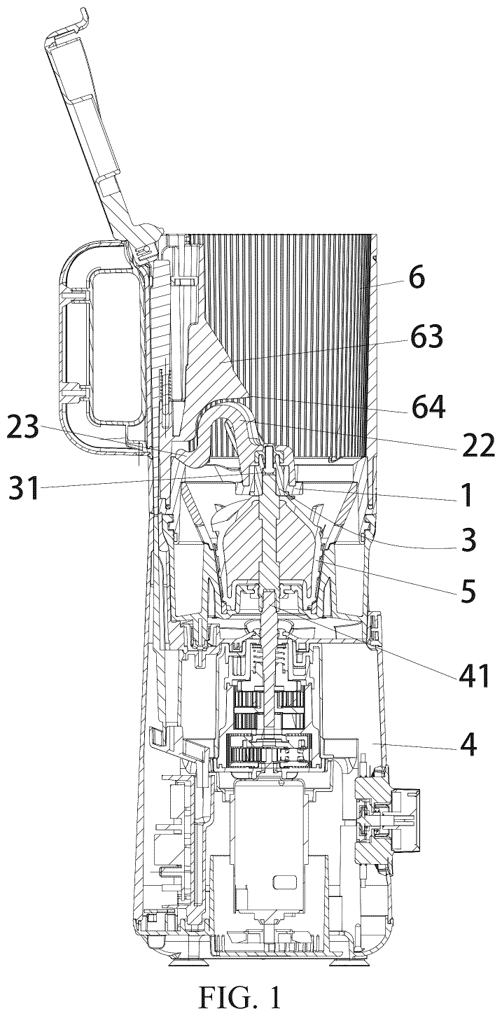

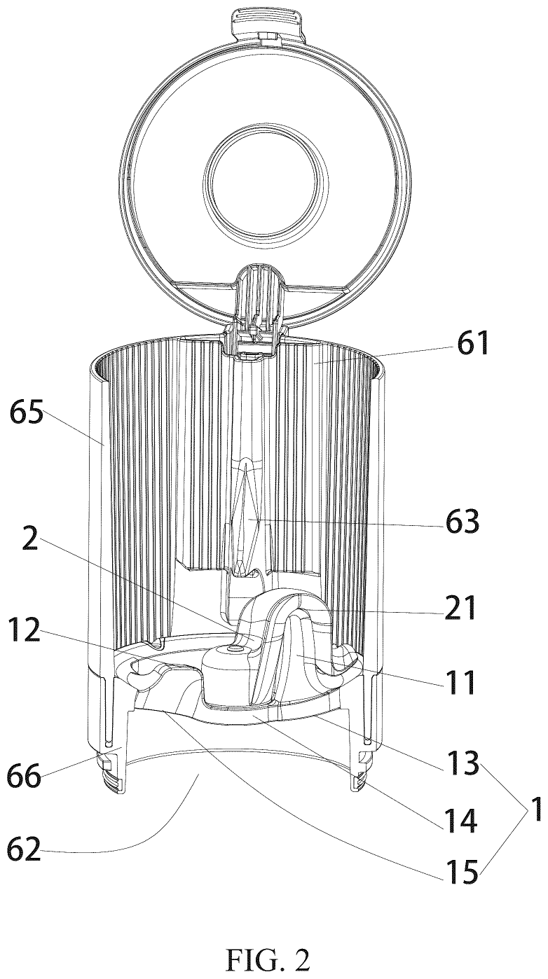

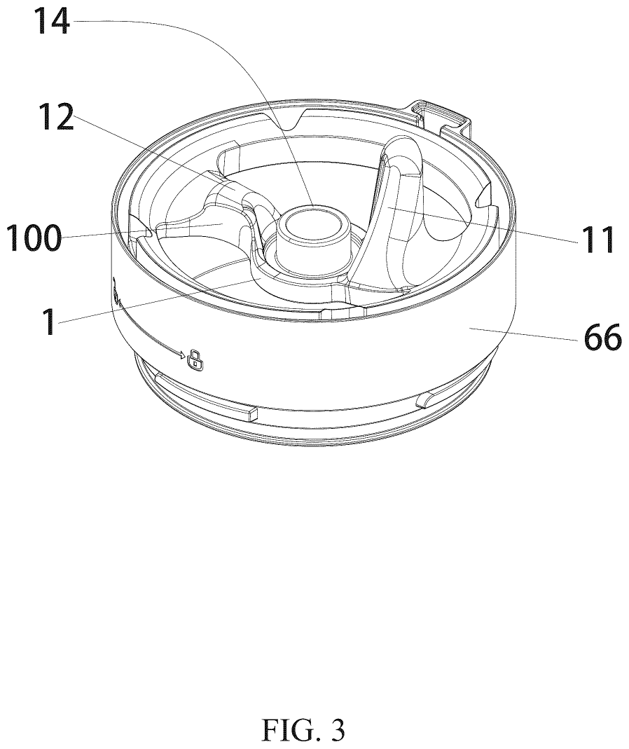

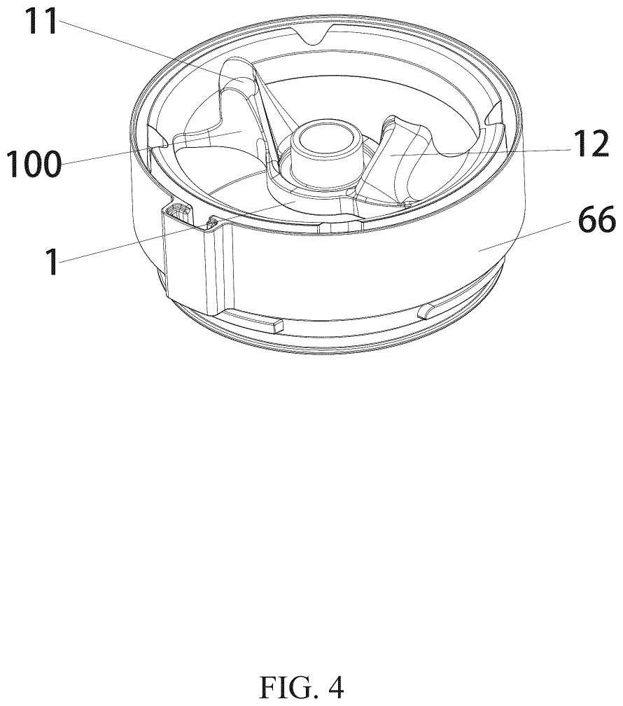

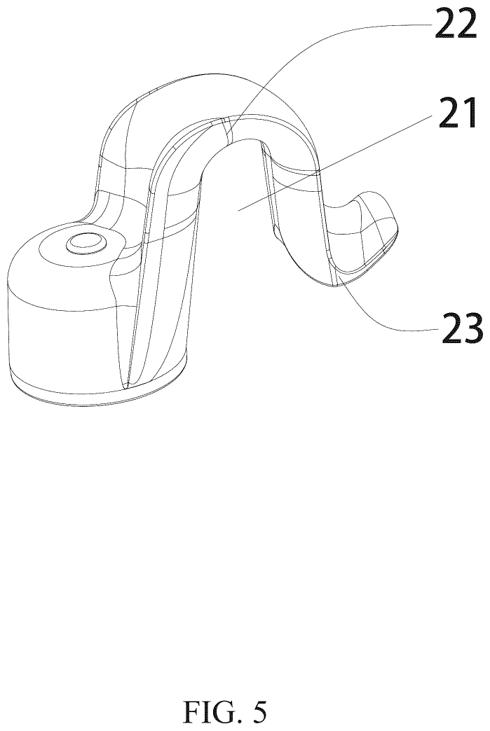

In Embodiment 1, combined with FIGS. 1 to 5, FIG. 1 shows a food processor internally provided with the cutting tool device of the present invention, and FIG. 2 shows a feeding cylinder of the food processor, and the feeding cylinder is equipped with the cutting tool device of the present invention: a cutting tool device comprises a cutting tool holder 1, and a first cutting tool 2 thereon, wherein the cutting tool holder 1 is provided with a first blocking portion 11 on one side of the connection between the cutting tool holder 1 and the first cutting tool 2, and an avoidance space 21 is provided on the first cutting tool 2 corresponding to the position of the first blocking portion 11.

As a specific solution, a second blocking portion 12 is further provided on the cutting tool holder 1, and the first cutting tool 2 comprises a first cutting section 22 on which an avoidance space 21 is provided, and a second cutting section 22 which inner surface is close to the outer surface of the second blocking portion 12.

In the embodiment, the second blocking portion 12 is located on the other side of the connection between the cutting tool holder 1 and the first cutting tool 2, and the highest point of the second blocking portion 12 is lower than the highest point of the first blocking portion 11.

In the embodiment, the first cutting section 22 is in an inverted “U” shape, the second cutting section 23 is in a “U” shape, and the first cutting section 22 and the second cutting section 23 are integrally formed.

In the embodiment, the first blocking portion 11 and the second blocking portion 12 are both provided with material guide slopes 100.

As a more specific solution, the cutting tool holder 1 comprises a left support section 13, a central connection portion 14, and a right support section 15 connected in sequence, one end of the first cutting tool 2 is rotatably connected to the central connection portion 14, the left support section 13 extends upward and is provided with the first blocking portion 11, and the right support section 15 extends upward and is provided with the second blocking portion 12.

As a better embodiment, the cutting tool device further comprises a tool connection assembly 3 that is rotatably connected to the central connection portion 14, the upper portion of the cutting tool connection assembly 3 is fixedly connected to the first cutting tool 2, and the lower portion of the cutting tool connection assembly 3 is provided with a driving hole 31.

As a better embodiment, the inner surface of the avoidance space 21 is close to the outer surface of the first blocking part 11.

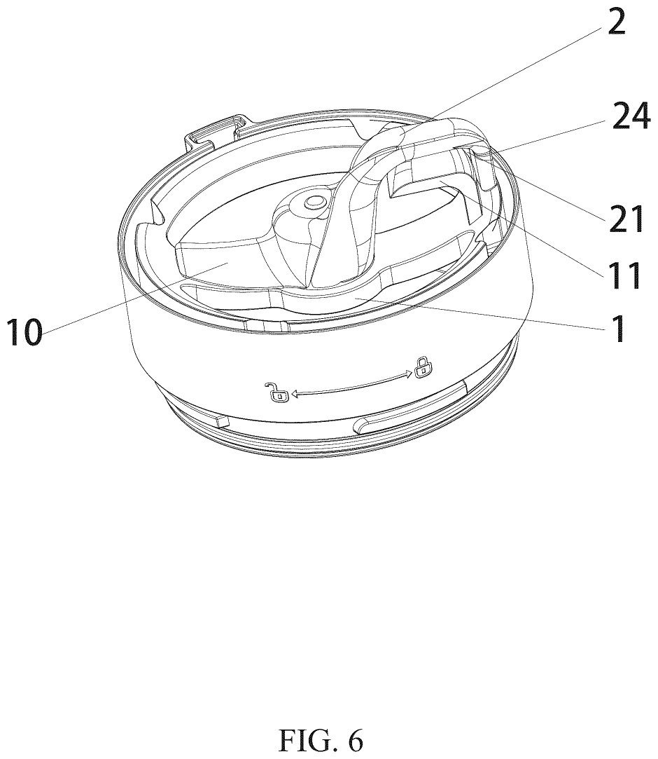

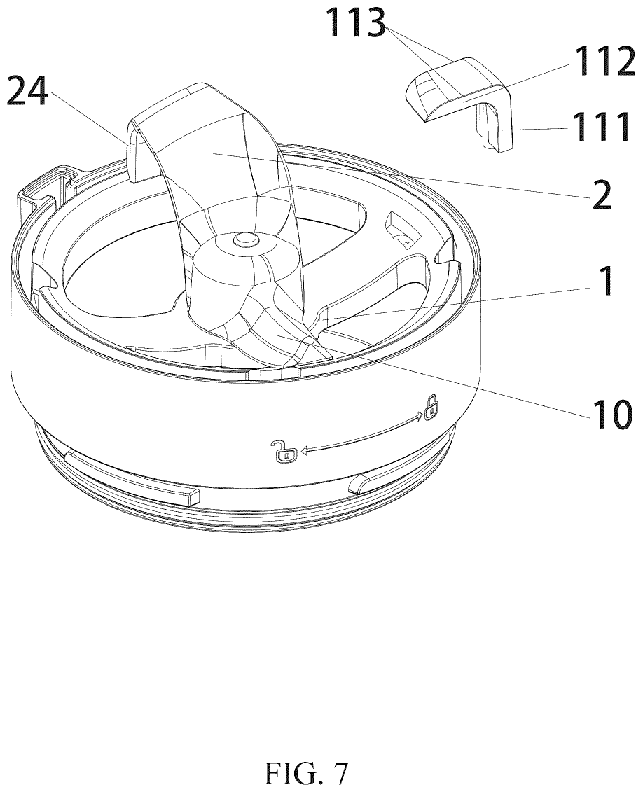

As shown in FIG. 6 and FIG. 7, this embodiment, as the second embodiment of the cutting tool device, is similar to the first embodiment, except for the following differences: a second cutting tool 10 is further provided on the first cutting tool 2 located on one side of the connection between the first cutting tool 2 and the cutting tool holder 1, and the first blocking portion 11 comprises a vertical section 111 and a horizontal section 112, the horizontal section 112 is connected to the upper portion of the vertical section 111, and when the second cutting tool 10 rotates through the first blocking portion 11, the second cutting tool 10 is close to the corresponding inner surfaces of the vertical section 111 and horizontal section 112.

As a more specific solution, cutting edges 113 are provided on both sides of the vertical section 111 and horizontal section 112.

In this embodiment, the first blocking portion 11 is detachably connected to the cutting tool holder 1.

In this embodiment, the outer side of the first cutting tool 2 further extends downward and is provided with a scraping portion 24.

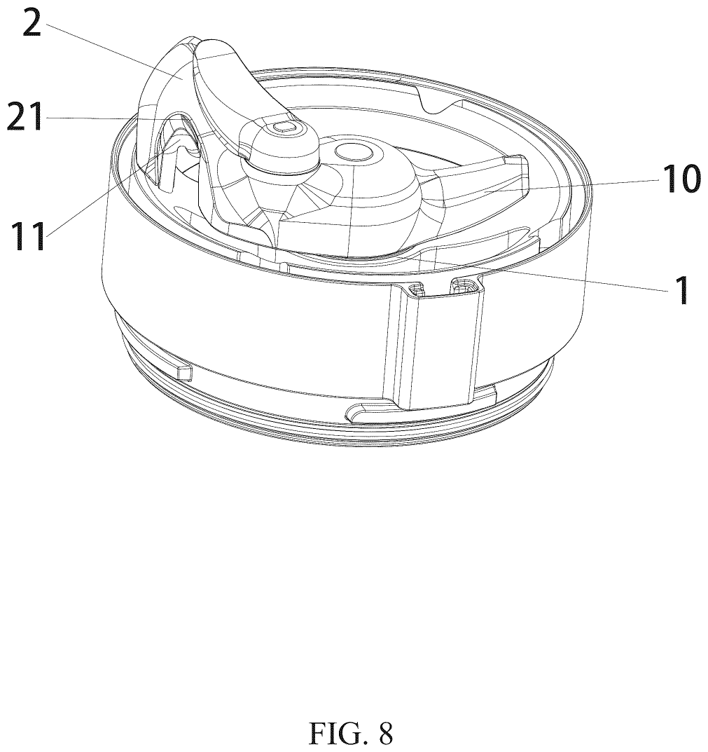

As shown in FIG. 8, this embodiment, as the third embodiment of the cutting tool device, is similar to the first embodiment, except for the following differences: a second cutting tool 10 is further provided on the first cutting tool 2 located on one side of the connection between the first cutting tool 2 and the cutting tool holder 1, the first blocking portion 11 is in a vertical hook shape, and when the second cutting tool 10 rotates through the first blocking portion 11, the second cutting tool 10 is close to the inner surface of the vertical hook shaped first blocking portion 11.

Referring to FIG. 1 to FIG. 5, a food processor comprising the above-mentioned cutting tool device, comprises a main body 4, a pressing assembly 5, and a feeding cylinder 6, the main body 4 is provided with an output shaft 41, the feeding cylinder 6 is provided with a feeding port 61 and a discharging port 62, the feeding cylinder 6 is internally provided with a cutting tool holder 1 and the first cutting tool 2, and the main body 4, through the output shaft 41, drives the pressing assembly 5 and first cutting tool 2 to rotate.

As a more specific solution, the inner wall of the feeding cylinder 6 is provided with a pre-cutting protrusion that is located above the first cutting tool 2, the pre-cutting protrusion 63 is provided with a pre-cutting tip 64, and the bottom surface of the pre-cutting protrusion 63 is close to the outer surface of the first cutting tool 2.

As a better embodiment, the feeding cylinder 6 comprises an upper cylinder 65 and a lower cylinder 66, the upper cylinder 65 is detachably fixed on the lower cylinder 66, the upper portion of the upper cylinder 65 is provided with a feeding port 61, the bottom of the lower cylinder 66 is provided with a discharging port 62, and the lower cylinder 66 is integrally provided with a cutting tool holder 1 that is located near the discharging port 62.

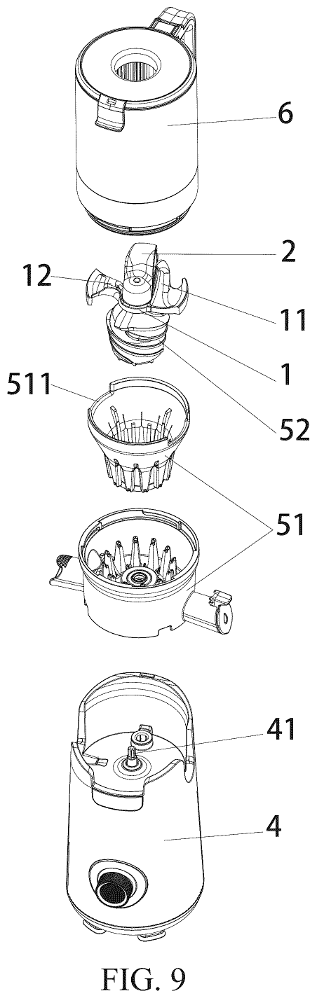

As shown in FIG. 9, this embodiment, as the second embodiment of the food processor, is similar to the above-mentioned food processor, except for the following differences: a food processor comprising the above-mentioned cutting tool device, comprises a main body 4, a pressing assembly 5, and a feeding cylinder 6, the main body 4 is provided with an output shaft 41, the feeding cylinder 6 is provided with a feeding port 61 and a discharging port 62, the pressing assembly 5 is internally provided with the cutting tool holder 1 and the first cutting tool 2, and the main body 4, through the output shaft 41, drives the pressing assembly 5 and first cutting tool 2 to rotate.

As a more specific solution, the pressing assembly 5 comprises a filter screen 51, and a transmission screw 52 that is placed inside the filter screen 51, the lower portion of the transmission screw 52 is connected to the output shaft 41 of the main body 4, and the upper portion of the transmission screw 52 is provided with a screw shaft 521 that is connected to the first cutting tool 2.

In this embodiment, the upper portion of the filter screen 51 is provided with two opposite placement grooves 511, and the two ends of the cutting tool holder 1 are respectively placed onto the two placement grooves 511 on the upper portion of the filter screen 51, and the cutting tool holder 1 is located above the transmission screw 52.

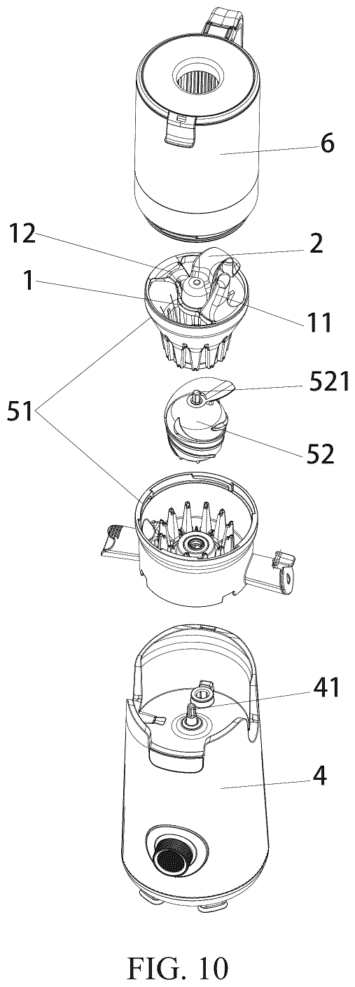

As shown in FIG. 10, this embodiment, as the third embodiment of the food processor, is similar to the second embodiment, except for the following differences: the two ends of the cutting tool holder 1 are integrally formed with the upper portion of the filter screen 51, and the cutting tool holder 1 is located above the transmission screw 52.

What is claimed is:

1. A cutting tool device, comprising a cutting tool holder (1), and a first cutting tool (2) thereon, wherein the cutting tool holder (1) is provided with a first blocking portion (11) on one side of the connection between the cutting tool holder (1) and the first cutting tool (2), and an avoidance space (21) is provided on the first cutting tool (2) corresponding to the position of the first blocking portion (11).

2. The cutting tool device according to claim 1, wherein a second blocking portion (12) is further provided on the cutting tool holder (1), and the first cutting tool (2) comprises a first cutting section (22) on which an avoidance space (21) is provided, and a second cutting section (23) which inner surface is close to the outer surface of the second blocking portion (12).

3. The cutting tool device according to claim 2, wherein the second blocking portion (12) is located on the other side of the connection between the cutting tool holder (1) and the first cutting tool (2), and the highest point of the second blocking portion (12) is lower than the highest point of the first blocking portion (11).

4. The cutting tool device according to claim 3, wherein the first cutting section (22) is in an inverted “U” shape, the second cutting section (23) is in a “U” shape, and the first cutting section (22) and the second cutting section (23) are integrally formed.

5. The cutting tool device according to claim 2, wherein the first blocking portion (11) and the second blocking portion (12) are both provided with material guide slopes (100).

6. The cutting tool device according to claim 2, wherein the cutting tool holder (1) comprises a left support section (13), a central connection portion (14), and a right support section (15) connected in sequence, one end of the first cutting tool (2) is rotatably connected to the central connection portion (14), the left support section (13) extends upward and is provided with the first blocking portion (11), and the right support section (15) extends upward and is provided with the second blocking portion (12).

7. The cutting tool device according to claim 6, further comprising a tool connection assembly (3) that is rotatably connected to the central connection portion (14), and the upper portion of the cutting tool connection assembly (3) is fixedly connected to the first cutting tool (2), and the lower portion of the cutting tool connection assembly (3) is provided with a driving hole (31).

8. The cutting tool device according to claim 1, wherein a second cutting tool (10) is further provided on the first cutting tool (2) located on one side of the connection between the first cutting tool (2) and the cutting tool holder (1), and the first blocking portion (11) comprises a vertical section (111) and a horizontal section (112), the horizontal section (112) is connected to the upper portion of the vertical section (111), and when the second cutting tool (10) rotates through the first blocking portion (11), the second cutting tool (10) is close to the corresponding inner surfaces of the vertical section (111) and horizontal section (112).

9. The cutting tool device according to claim 8, wherein cutting edges (113) are provided on both sides of the vertical section (111) and horizontal section (112).

10. The cutting tool device according to claim 8, wherein the first blocking portion (11) is detachably connected to the cutting tool holder (1).

11. The cutting tool device according to claim 8, wherein the outer side of the first cutting tool (2) further extends downward and is provided with a scraping portion (24).

12. The cutting tool device according to claim 1, wherein a second cutting tool (10) is further provided on the first cutting tool (2) located on one side of the connection between the first cutting tool (2) and the cutting tool holder (1), the first blocking portion (11) is in a vertical hook shape, and when the second cutting tool (10) rotates through the first blocking portion (11), the second cutting tool (10) is close to the inner surface of the vertical hook shaped first blocking portion (11).

13. A food processor comprising a cutting tool device according to claim 1, comprising a main body (4), a pressing assembly (5), and a feeding cylinder (6), the main body (4) is provided with an output shaft (41), the feeding cylinder (6) is provided with a feeding port (61) and a discharging port (62), the feeding cylinder (6) is internally provided with a cutting tool holder (1) and the first cutting tool (2), and the main body (4), through the output shaft (41), drives the pressing assembly (5) and first cutting tool (2) to rotate.

14. The food processor according to claim 13, wherein the inner wall of the feeding cylinder (6) is provided with a pre-cutting protrusion that is located above the first cutting tool (2), the pre-cutting protrusion (63) is provided with a pre-cutting tip (64), and the bottom surface of the pre-cutting protrusion (63) is close to the outer surface of the first cutting tool (2).

15. The food processor according to claim 13, wherein the feeding cylinder (6) comprises an upper cylinder (65) and a lower cylinder (66), the upper cylinder (65) is detachably fixed on the lower cylinder (66), the upper portion of the upper cylinder (65) is provided with a feeding port (61), the bottom of the lower cylinder (66) is provided with a discharging port (62), and the lower cylinder (66) is integrally provided with a cutting tool holder (1) that is located near the discharging port (62).

16. A food processor comprising a cutting tool device according to claim 1, comprising a main body (4), a pressing assembly (5), and a feeding cylinder (6), the main body (4) is provided with an output shaft (41), and the feeding cylinder (6) is provided with a feeding port (61) and a discharging port (62), the pressing assembly (5) is provided with a cutting tool holder (1) and a first cutting tool (2), and the main body (4), through the output shaft (41), drives the pressing assembly (5) and first cutting tool (2) to rotate.

17. The food processor according to claim 16, wherein the pressing assembly (5) comprises a filter screen (51), and a transmission screw (52) that is placed inside the filter screen (51), the lower portion of the transmission screw (52) is connected to the output shaft (41) of the main body (4), and the upper portion of the transmission screw (52) is provided with a screw shaft (521) that is connected to the first cutting tool (2).

18. The food processor according to claim 17, wherein the upper portion of the filter screen (51) is provided with two opposite placement grooves (511), and the two ends of the cutting tool holder (1) are respectively placed onto the two placement grooves (511) on the upper portion of the filter screen (51), and the cutting tool holder (1) is located above the transmission screw (52).

19. The food processor according to claim 17, wherein the two ends of the cutting tool holder (1) are integrally formed with the upper portion of the filter screen (51), and the cutting tool holder (1) is located above the transmission screw (52).
